(19) United States
(12) Patent Application Publication
(10) Pub. No.: US 2026/0003532 A1
(43) Pub. Date: Jan. 1, 2026

(54) STORAGE SYSTEM AND STORAGE CONTROL METHOD

(71) Applicant: Hitachi Vantara, Ltd., Kanagawa-ken (JP)

(72) Inventors: Norio SHIMOZONO, Tokyo (JP); Koji HOSOGI, Tokyo (JP); Kazuki MATSUGAMI, Tokyo (JP); Takaki MATSUSHITA, Tokyo (JP)

(21) Appl. No.: 19/078,863

(22) Filed: Mar. 13, 2025

(30) Foreign Application Priority Data
Jun. 28, 2024 (JP) 2024-105313

(51) Int. Cl. G06F 3/06

(52) U.S. Cl. CPC G06F 3/065; G06F 3/0638; G06F 3/067

(57) ABSTRACT

A second storage device stores data of a clone volume in a pool of the second storage device, and when the data is not stored in the pool of the second storage device, acquires the data from a pool of a first storage device and stores the data in the pool of the second storage device, and enables data related to a primary volume stored in the pool of the second storage device to be commonly accessed by a plurality of the clone volumes.

### CROSS-REFERENCE TO PRIOR APPLICATION

This application relates to and claims the benefit of priority from Japanese Patent Application number 2024-105313, filed on Jun. 28, 2024 the entire disclosure of which is incorporated herein by reference.

### BACKGROUND OF THE INVENTION

### 1. Field of the Invention

The present invention relates to a storage system and a storage control method, and is suitably applied to a storage control method in a storage system relating to a technique for copying data via a network between a first environment and a second environment.

### 2. Description of Related Art

For example, PTL 1 discloses a storage system capable of executing virtual copying by a redirect on write (ROW) method. In a technique disclosed in PTL 1, first control information associated with a volume one to one, and second control information for managing user data are managed in a tree structure, and a copy of a volume is created at high speed by copying only the first control information.

In recent years, there has been an increasing need for utilization of data, and examples of such a need include use of data stored in a first environment in a second environment. Examples include using data stored in a database of a mission-critical environment in a data analysis environment, and using data stored in a production environment in work in a development environment or a test environment to perform a test. When analyzing and testing these pieces of data, distributed processing using a large number of computers is generally performed in order to increase a speed. In order to achieve such a need, it is necessary to create a plurality of copies of volumes in a storage system installed in a physically separated environment according to the number of computers.

As a method of applying the technique disclosed in PTL 1 to the above-described need, a method is conceivable to perform a full copy of a volume once from a storage device in a first environment to a storage device in a second environment, and then further copy a required number of volumes in the second environment. In addition, as another method of applying the technique disclosed in PTL 1 to the need described above, it is also conceivable to copy a required number of volumes in the first environment, then copy these volumes to the second environment, and a computer in the second environment can access these volumes.

### CITATION LIST

### Patent Literature

PTL 1: JP2022-26812A

### SUMMARY OF THE INVENTION

However, in the technique disclosed in PTL 1, a load of a network bandwidth between the storage devices between the first environment and the second environment becomes a bottleneck, and it takes a long time to fully copy the volume. In addition, if the volume is fully copied every time, a storage capacity of the storage system in the second environment is greatly consumed. In addition, in the technique disclosed in PTL 1, all access to data from the computer in the second environment passes through a network between the storage devices, resulting in extremely poor performance in accessing data.

In view of the foregoing, it is an object of the invention to provide a storage system and a storage control method capable of speeding up data access in a second environment while reducing a load of a network bandwidth between a first environment and the second environment.

In order to solve such problems, the invention provides a storage system including a first storage device and a second storage device each having a processor and a pool and connected via a network. The first storage device includes a primary volume, the second storage device includes a plurality of clone volumes that are clones of the primary volume, and the second storage device stores data of each of the clone volumes in the pool of the second storage device, and when the data is not stored in the pool of the second storage device, acquires the data from the pool of the first storage device and stores the data in the pool of the second storage device, and enables data related to the primary volume stored in the pool of the second storage device to be commonly accessed by the plurality of clone volumes.

The invention provides a storage control method for a storage system including a first storage device and a second storage device each having a processor and a pool and connected via a network. The first storage device includes a primary volume, and the second storage device includes a plurality of clone volumes that are clones of the primary volume. The storage control method includes: the second storage device storing data of each of the clone volumes in the pool of the second storage device, and when the data is not stored in the pool of the second storage device, acquiring the data from the pool of the first storage device and storing the data in the pool of the second storage device, and enabling data related to the primary volume and stored in the pool of the second storage device to be commonly accessed by the plurality of clone volumes.

According to the invention, it is possible to speed up data access in the second environment while reducing the load of the network bandwidth between the first environment and the second environment.

### BRIEF DESCRIPTION OF THE DRAWINGS

FIG. 1 is a system configuration diagram illustrating a storage system according to a first embodiment;

FIG. 2 is a block diagram illustrating an example of a hardware structure of a storage device;

FIG. 3 is a diagram illustrating a configuration example of a memory illustrated in FIG. 2;

FIG. 4 is a diagram illustrating an example of a volume management table;

FIG. 5A is a diagram illustrating an example of an address translation table including invalid values;

FIG. 5B is a diagram illustrating an example of an address translation table not including an invalid value;

FIG. 6 is a diagram illustrating an example of a page management table;

FIG. 7 is a diagram illustrating an example of an external volume management table;

FIG. 8 is a flowchart illustrating an example of a procedure of clone creation processing;

FIG. 9 is a flowchart illustrating an example of a procedure of clone deletion processing;

FIG. 10 is a flowchart illustrating an example of a procedure of virtual volume write processing;

FIG. 11 is a flowchart illustrating an example of a procedure of virtual volume read processing;

FIG. 12 is a sequence diagram when a plurality of remote clone volumes are configured;

FIG. 13 is a block diagram illustrating a logical configuration example of a storage system according to a second embodiment;

FIG. 14 is a diagram illustrating a configuration example of a memory of a storage device;

FIG. 15 is a sequence chart illustrating an example of a procedure for switching an external volume to a new snapshot volume; and

FIG. 16 is a flowchart illustrating an example of a procedure of cache shared volume synchronization processing.

### DESCRIPTION OF EMBODIMENTS

Hereinafter, embodiments according to the invention will be described with reference to the drawings.

### (1) First Embodiment

### (1-1) System Configuration

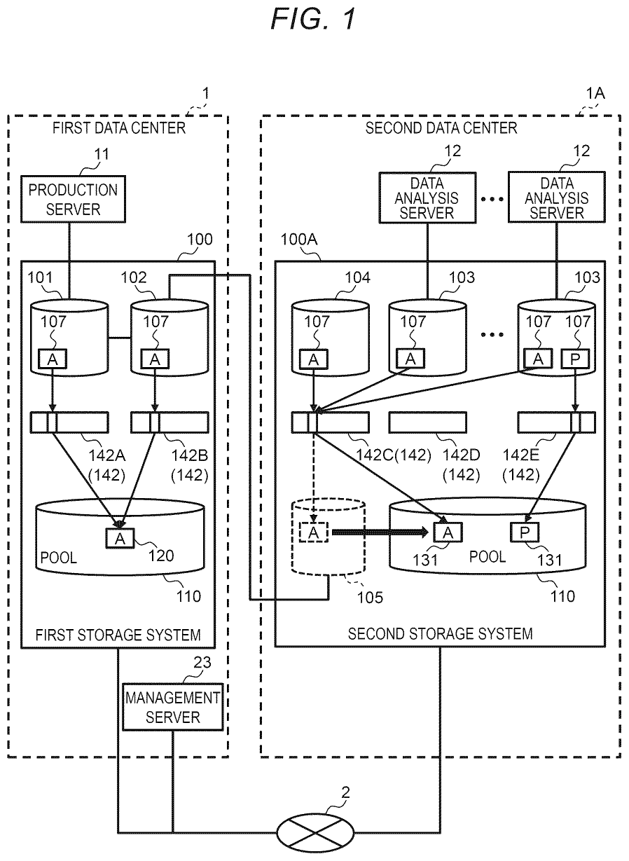

FIG. 1 is a block diagram illustrating an example of a logical configuration of a storage system according to a first embodiment. The storage system according to the first embodiment includes an on-premise environment as an example of a first environment, and a public cloud environment (hereinafter abbreviated as a “cloud environment”) as an example of a second environment, and includes a first storage device 100 and a management server 23 in the on-premise environment, a second storage device 100A in the cloud environment, and a network between storages connecting these devices (hereinafter referred to as a “network”) 2. In FIG. 1, a part of the network configuration is omitted for simplification of description.

Here, since the first storage device 100 and the second storage device 100A have substantially the same configuration except for a logical configuration such as a volume set by a user, the first storage device 100 and the second storage device 100A may be collectively referred to as a “storage device 100” or a “node” when it is not necessary to particularly distinguish the first storage device 100 and the second storage device 100A.

The storage device 100 is, for example, a storage system that adopts a loosely coupled scale-out architecture, and includes a plurality of data centers 1, 1A (for example, a first data center and a second data center). As illustrated in FIG. 1, each of the data centers 1, 1A has a pool 110, a page 120, and a primary volume 101 as a logical configuration. The storage that adopts the loosely coupled scale-out architecture has a scale-out function that enables performance or a capacity to be expanded as needed from a small-scale configuration. A loosely coupled scale-out method in which a plurality of appliances (data centers 1, 1A) are clustered is mainstream, and the storage device 100 illustrated in FIG. 1 also adopts this scale-out method, but the invention is not limited thereto.

The storage system according to the first embodiment includes the first storage device 100 and the second storage device 100A each having a central processing unit (CPU) as an example of a processor and the pool 110 and connected via the network 2. The first storage device 100 includes the primary volume 101 capable of storing data, and reads and writes data in response to a request from the production server 11 as an example of a host device. In contrast, the second storage device 100A includes the pool 110 capable of storing data, and provides data in response to access from the data analysis server 12 that is an example of a virtual computer (application VM) implemented by an application, for example. The second storage device 100A includes a plurality of remote clone volumes (hereinafter, sometimes abbreviated as “clone volumes”) 103 as an example of clone volumes that are clones of the primary volume 101. The second storage device 100A stores data of each of the clone volumes 103 in the pool 110 of the second storage device 100A, and when the data is not stored in the pool 110 of the second storage device 100A, acquires the data from the pool 110 of the first storage device 100 and stores the data in the pool 110 of the second storage device 100A. The data related to the primary volume 101 stored in the pool 110 of the second storage device 100A can be commonly accessed by a plurality of clone volumes 103.

The first storage device 100 is a storage device that reads and writes data in response to a request from the production server 11 in the data center 1 as an example of the first environment. The first storage device 100 includes the primary volume 101, a snapshot 107, address translation tables 142A, 142B, and the pool 110.

The second storage device 100A includes an external volume 105 associated with the primary volume 101 in the first storage device 100, a cache shared volume 104 for at least temporarily holding, for example, data of the primary volume 101 via the external volume 105, and the remote clone volume 103 as an example of a clone volume that is at least one volume implemented by copying the cache shared volume 104 as necessary and is accessed by the data analysis server 12, which is an example of the virtual computer. The virtual computer is not limited to the data analysis server 12, and may be a computer having another function of using data stored in the remote clone volume 103. Hereinafter, details will be described.

The page 120 is a logical storage device (logical volume) managed by the storage device 100, and the pool 110 is created by aggregating at least one page 120. The primary volume 101 is a virtual volume. In the primary volume 101, for example, data is managed in units of pages.

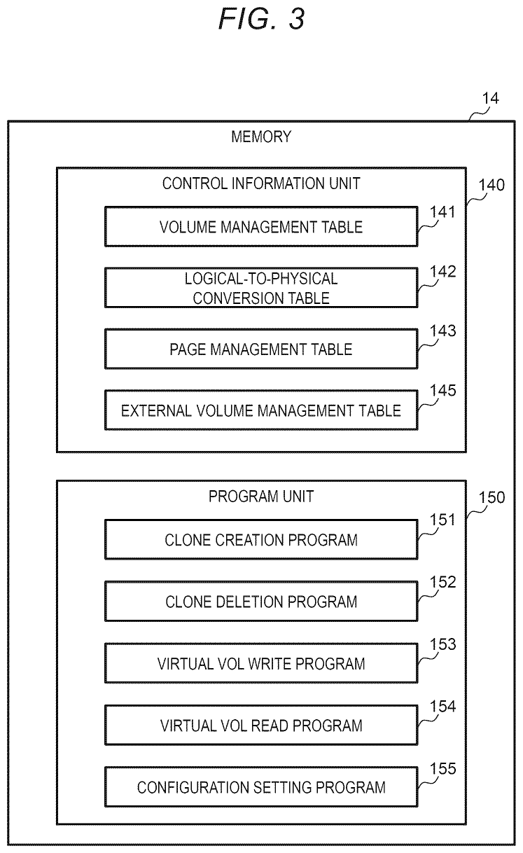

The primary volume 101 is associated with a pool to which the primary volume 101 belongs (the pool 110 from which the primary volume 101 is created) by a volume management table (corresponding to a volume management table 141 illustrated in FIG. 3) to be described later. An address to which the page is allocated is managed by a page management table (corresponding to a page management table 143 illustrated in FIG. 3) to be described later. For example, in a case of FIG. 1, the primary volume 101 is associated with the pool 110 including the page 120, and has, for example, a page 107 of “A”. An address of the page 107 of “A” in the primary volume 101 is translated by the address translation table 142A, and is allocated to the page 120 of “A” in the pool 110.

The first storage device 100 acquires the snapshot volume 102 of the primary volume 101 at a certain point in time using, for example, a snapshot method as an example of a difference data acquisition method. Here, the snapshot volume 102 includes a page 107 of “A” so as to correspond to the primary volume 101 having a page 107 of “A”, for example. For example, in the case of FIG. 1, the snapshot volume 102 is associated with the pool 110 including the page 120, and the address of the page 107 of “A” of the snapshot volume 102 is translated by the address translation table 142B and allocated to the page 120 of “A” in the pool 110.

Meanwhile, in the second data center 1A as an example of the second environment, the second storage device 100A at least reads data in response to access from the data analysis server 12 implemented by, for example, a virtual computer, and provides the data to the data analysis server 12. The second storage device 100A may be configured so that data may be written in response to a request from the data analysis server 12.

The second storage device 100A includes, in addition to the above-described external volume 105, cache shared volume 104, and at least one remote clone volume 103, an address translation table 142C (first address translation table), an address translation table 142D (second address translation table), and an address translation table 142E. The external volume 105, the cache shared volume 104, and the at least one remote clone volume 103 correspond to the address translation table 142C, the address translation table 142D, and the address translation table 142E, respectively. Details of the address translation table 142C, the address translation table 142D, and the address translation table 142E will be described later.

In the storage system according to the present embodiment, a plurality of clone volumes 103 can access data of the same primary volume 101, and the data can be written to the plurality of clone volumes 103 separately. The storage system includes the address translation table 142C as an example of the first address translation table that manages a correspondence relation of address information relating to storage addresses of data between the pool 110 and the cache shared volume 104. The second storage device 100A registers, in the address translation table 142C, address information relating to the storage address of the data staged from the primary volume 101 in the first storage device 100 to the cache shared volume 104.

In the storage system, the second storage device 100A includes the address translation table 142C as an example of the first address translation table for accessing the data related to the primary volume 101, and address translation tables 142D to 142E as examples of the second address translation table for each of the plurality of clone volumes 103, accesses, via the first address translation table 142C, data that is related to the primary volume 101 and stored in the pool 110 of the first storage device 100 and the pool 110 of the second storage device 100A, and accesses, via the second address translation tables 142D to 142E, data written to the clone volume 103 and stored in the pool 110 of the second storage device 100A. Each of the address translation tables 142D to 142E manages correspondence relation of address information relating to storage addresses of data between the pool 110 and the remote clone volume 103. The second storage device 100A registers, in the address translation table 142D for the remote clone volume 103, address information relating to a storage address of data written from the data analysis server 12 to the remote clone volume 103.

The clone volume 103 refers to the second address translation tables 142D to 142E for data to be written to the clone volume 103, refers to the first address translation table 142C for the data related to the primary volume 101, and when the data related to the primary volume 101 is acquired from the first storage device 100 and stored in the second storage device 100A, changes a reference destination of the first address translation table 142C from the pool 110 of the first storage device 100 to the pool 110 of the second storage device 100A. In the present embodiment, when the clone volume 103 is created in the second storage device 100A, the first storage device 100 has a snapshot of the primary volume 101, and the second storage device 100A creates the cache shared volume 104 and the first address translation table 142C that is an address translation table referred to by the cache shared volume 104 and that refers to the snapshot volume via the external volume 105, and copies the cache shared volume 104 to create the clone volume referring to the first address translation table 142C, and creates the second address translation tables 142D to 142E in which a storage destination address of the data written in the clone volume 103 is registered. In the present embodiment, the first storage device 100 has a plurality of snapshots created at different times for the same primary volume 101, and when changing a reference destination snapshot of the first address translation table 142C to another snapshot created from the same primary volume 101, uses difference information between the snapshot before the change and the snapshot after the change to acquire data related to a difference from the first storage device 100 and store the data in the pool 110 of the second storage device 100A, and after the reference destination snapshot is changed, accesses the data stored in the pool 110 of the second storage device 100A before the change and after the change from the clone volume 103. The plurality of remote clone volumes 103 are implemented by copying a plurality of cache shared volumes 104. The address translation tables are provided in a number corresponding to the plurality of remote clone volumes 103. The second storage device 100A registers data written from the data analysis server 12 to each remote clone volume 103 in the address translation table 142D corresponding to the remote clone volume 103.

In a case where the data analysis server 12 accesses data in the remote clone volume 103, when address information related to a storage address of the accessed data in the address translation table 142D is an invalid value (for example, “FFFFFFFF”), the second storage device 100A searches for the address information in the address translation table 142C corresponding to the cache shared volume 104, and when the address information obtained as a search result is a valid value, reads the data from the pool 110, which is a destination of address translation using the address translation table 142C, and when the address information obtained as the search result is an invalid value, stores the data read from the primary volume 101 via the external volume 105 in the cache shared volume 104 and registers address information corresponding to the read data in the address translation table 142C corresponding to the cache shared volume 104.

When the data analysis server 12 accesses data in the remote clone volume 103, the second storage device 100A searches the address translation table 142C corresponding to the cache shared volume 104, and when the address information obtained as a search result is a valid value, registers in the address translation table 142D corresponding to the remote clone volume 103 a valid value to be reflected in address information related to the accessed data.

When newly creating a cache shared volume 104 by copying the external volume 105, the second storage device 100A initializes address information of the address translation table 142C corresponding to the cache shared volume 104 with an invalid value.

When newly creating a remote clone volume 103, the second storage device 100A: initializes the address translation table 142D by copying the address translation table 142C corresponding to the cache shared volume 104 as the corresponding address translation table 142D.

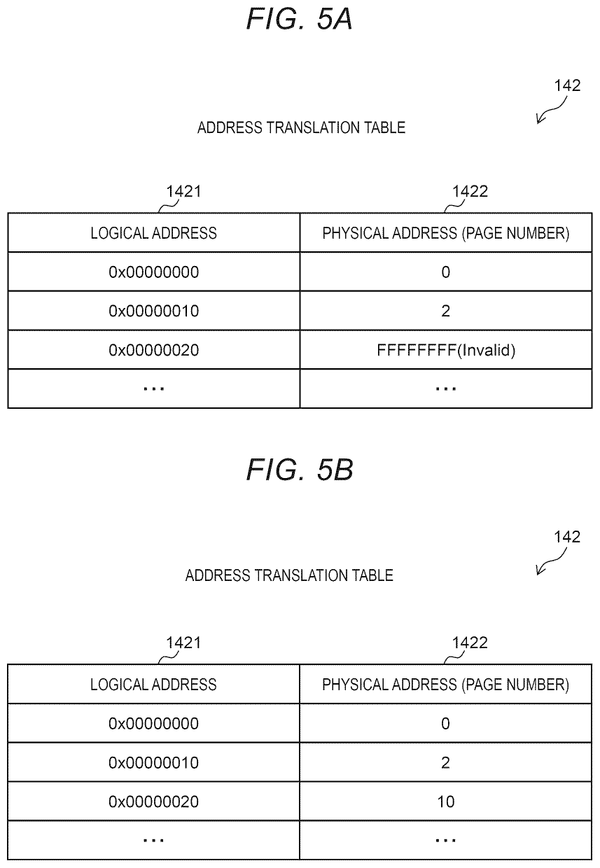

In response to a data write request by the data analysis server 12 to the remote clone volume 103, the second storage device 100A stores data in the pool 110 and registers address information of the data in the address translation table 142D corresponding to the remote clone volume 103. In response to a data read request by the data analysis server 12 from the remote clone volume 103, the second storage device 100A refers to the address translation table 142D corresponding to the remote clone volume 103, and when the address information of the address translation table 142D is an invalid value (for example, “FFFFFFFF (Invalid)” in FIG. 5), refers to the address translation table 142C corresponding to the cache shared volume 104, and when a valid value of the address information is found in either the address translation table 142D or the address translation table 142C, reads the data from the pool 110 based on address information of the valid value. When a valid value of the address information is not found in either the address translation table 142D or the address translation table 142C, the second storage device 100A reads the data via the external volume 105, stores the read data in the pool 110 and the cache shared volume 104, and updates address information of the address translation table 142C corresponding to the cache shared volume 104. When there is no difference prefetch request from the management server 23, for example, the second storage device 100A sets the address translation table 142C corresponding to the cache shared volume 104 to invalid. In this case, in the present embodiment, instead, information for connecting to the external volume 105 and a snapshot volume ahead thereof can be used. Meanwhile, when there is a difference prefetch request from the management server 23, the second storage device 100A acquires data from the pool 110 of the first storage device 100 and stores the data in the pool 110 of the second storage device 100A.

In the above embodiment, the clone volume 103 refers to the address translation tables 142D to 142E for data to be written to the clone volume 103, refers to the address translation table 142C for the data related to the primary volume 101, and when the data related to the primary volume 101 is acquired from the first storage device 100 and stored in the second storage device 100A, changes a reference destination of the first address translation table 142C from the pool 110 of the first storage device 100 to the pool 110 of the second storage device 100A.

In the above embodiment, when the clone volume 103 is created in the second storage device 100A, the first storage device 100 has a snapshot of the primary volume 101, and the second storage device 100A creates the cache shared volume 104 and the address translation table 142C that is an address translation table referred to by the cache shared volume 104 and that refers to the snapshot volume via the external volume 105, copies the cache shared volume 104 to create the clone volume referring to the first address translation table 142C, and creates the address translation tables 142D to 142E in which a storage destination address of the data written in the clone volume 103 is registered.

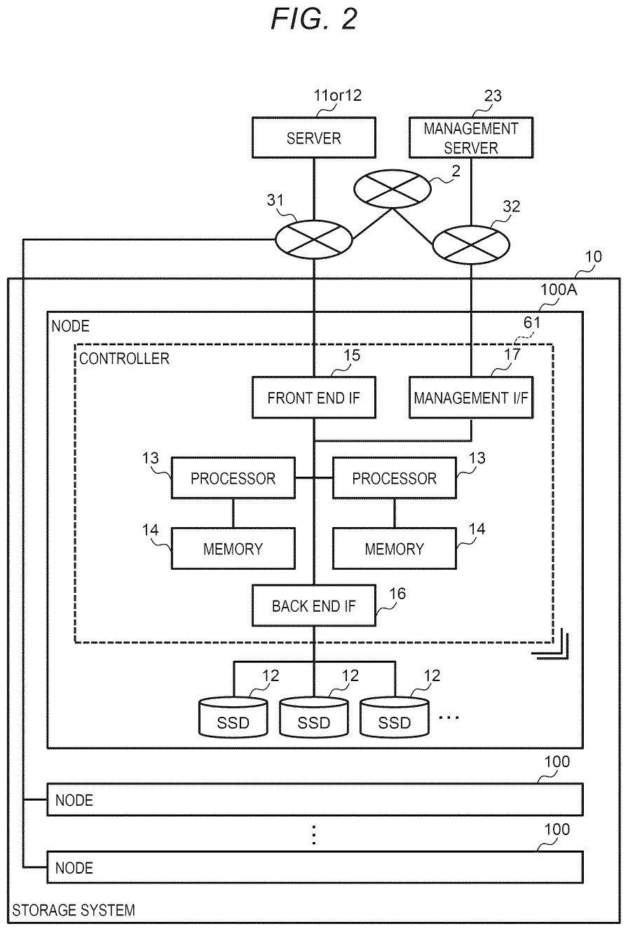

FIG. 2 is a block diagram illustrating an example of a hardware structure of a storage device of the storage system according to the first embodiment. Since the first storage device 100 and the second storage device 100A have a similar hardware structure, the second storage device 100A will be described below in the illustrated example. In the illustrated example, a network configuration example is illustrated in a simplified manner. The second storage device 100A is connected to the production server 11 and the data analysis server 12 via a storage network 31, and is connected to the management server 23 via a management network 32.

The production server 11 is a server that operates in a production environment that handles business data as an example of data. The data analysis server 12 is a server that performs data analysis on data provided from the second storage device 100A. The production server 11 and the data analysis server 12, as a host, transmit an I/O request (write request or read request) designating an input and output destination to a controller 61.

The management server 23 is a server that manages the storage device. The management server 23 manages the storage device via the management network 32.

The storage network 31 is, for example, a fiber channel (FC) network, and the management network 32 is, for example, an internet protocol (IP) network. The storage network 31 and the management network 32 may be the same communication network.

The second storage device 100A includes at least one controller 61 and a plurality of physical drives 18 (solid state drive: SSD) from and to which data reading and writing are controlled by the controller 61. The physical drive 18 is connected to each controller 61, and one or a plurality of physical drives 18 are allocated to the controller 61. In FIG. 2, a solid state drive (SSD) is illustrated as an example of the physical drive 18, but the invention is not limited thereto, and the physical drive 18 may be a device that physically stores data, such as a hard disk drive (HDD).

The controller 61 includes at least one processor 13, at least one memory 14, a front end IF 15, a back end IF 16, and a management IF 17.

The processor 13 is a processor that achieves various kinds of controls by executing a program read from the memory 14. In the present embodiment, the processor 13 executes control related to writing and reading of data in addition to creating and deleting clones. The processor 13 is, for example, a central processing unit (CPU), but the invention is not limited thereto.

The memory 14 is a storage device that stores a program executed by the processor 13, data used by the processor 13, and the like. In the present embodiment, for example, as illustrated in FIG. 2, data in each memory 14 is duplicated by a set of the processor 13 and the memory 14.

The front end IF 15 is a communication interface device that mediates data exchange between the production server 11 or the data analysis server 12 and the controller 61. The controller 61 is connected to the production server 11 and the data analysis server 12 from the front end IF 15 via the storage network 31.

The back end IF 16 is a communication interface device that mediates data exchange between the physical drive 18 and the controller 61. A plurality of physical drives 18 are connected to the back end IF 16.

The management IF 17 is a communication interface device that mediates data exchange between the management server 23 and the controller 61. The controller 61 is connected to the management server 23 from the management IF 17 via the management network 32.

### (1-2) Memory Configuration

FIG. 3 is a diagram illustrating a configuration example of the memory 14 illustrated in FIG. 2. Programs and the control data stored in the memory 14 are executed and used by the processor 13.

The memory 14 includes a control information unit 140 that holds each table as an example of control data, and a program unit 150 that holds a program executed by the processor 13. The program unit 150 is a local memory used by the processor 13 (see FIG. 2) belonging to the same set as the memory 14. Meanwhile, the control information unit 140 may be a shared memory that can be used not only by the processor 13 belonging to the same set as the memory 14 but also by the processor 13 belonging to another set.

The control information unit 140 includes the volume management table 141, an address translation table 142, the page management table 143, and an external volume management table 145. Details of the volume management table 141, the address translation table 142, the page management table 143, and the external volume management table 145 will be described later.

The program unit 150 includes a clone creation program 151, a clone deletion program 152, a virtual volume write program (hereinafter abbreviated as “virtual VOL write program”) 153, a virtual volume read program (hereinafter abbreviated as “virtual VOL read program”) 154, and a configuration setting program 155.

The clone creation program 151 has a function of creating the remote clone volume 103 by copying the cache shared volume 104. The clone deletion program 152 has a function of deleting the existing remote clone volume 103.

The virtual VOL write program 153 has a function of writing data to the remote clone volume 103 or the pool 110 in response to access from the data analysis server 12. The virtual VOL read program 154 has a function of providing the data analysis server 12 with data stored in the remote clone volume 103 or the pool 110 in response to access from the data analysis server 12.

The configuration setting program 155 sets, for example, configurations of the cache shared volume 104, the remote clone volume 103, and the pool 110, and registers, updates, and deletes corresponding address information in the address translation tables 142C, 142D, and 142E according to the set configurations.

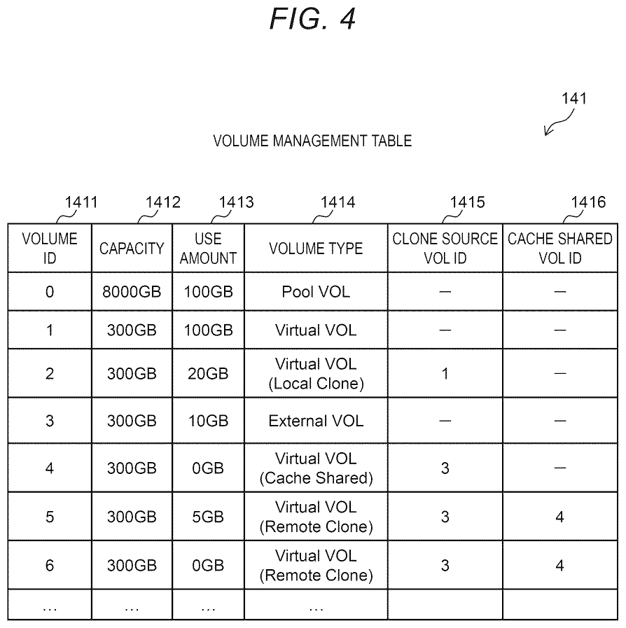

FIG. 4 is a diagram illustrating an example of the volume management table 141. The volume management table 141 is control data for managing volumes such as the page 120 and the primary volume 101. The volume management table 141 includes items which are a volume ID 1411, a capacity 1412, a use amount 1413, a volume type 1414, a clone source volume ID (IDentifier) 1415 (corresponding to the “clone source VOL ID” in the figure), and a cache shared volume ID (IDentifier) 1416 (corresponding to the “cache shared VOL ID” in the figure). In the following description, the volume ID may be abbreviated as “VOL ID”.

The volume ID 1411 is an identifier for identifying each volume. The capacity 1412 indicates a capacity allocated to a volume that is identified by the volume ID 1411 (hereinafter, the volume), and the use amount 1413 indicates a current use amount in the volume.

The volume type 1414 indicates a type of the volume. When the volume is a pool volume, a type thereof is indicated as “Pool VOL”, when the volume is a virtual volume, a type thereof is indicated as “Virtual VOL”, when the volume is a clone that is a local virtual copy of a volume, a type thereof is indicated as “(Local Clone)”, and when the volume is an external volume that is externally connected (external) from another data center different from a host data center, a type thereof is indicated as“(External VOL)”. When the volume is the cache shared volume 104, a type thereof is indicated as“(Cache Shared)”, and when the volume is the remote clone volume 103, a type thereof is indicated as “(Remote Clone)”.

The “externally connected (external)” in this specification means that mapping from the primary volume 101 of the host data center to the data in another data center is performed, and for this purpose, mapping of the page 120 associated with the primary volume 101 of the host data center and the primary volume 101 holding the data of the other data center is also included.

The clone source volume ID 1415 indicates a volume ID of the cache shared volume 104 as the clone source when a local clone volume is created for a volume corresponding to each volume ID. The local clone volume is a clone volume created on a first storage device 100 side. The cache shared volume ID 1416 indicates a volume ID of the cache shared volume 104 for the volume corresponding to each volume ID.

In the illustrated example, a volume having a volume ID “3” is the external volume 105, a volume having the volume ID “4” is the cache shared volume 104, and two volumes having the volume IDs “5” and “6” are two local clone volumes. These two local clone volumes have the cache shared volume ID 1416 of “4”, and therefore it is understood that the two local clone volumes are volumes obtained by copying the cache shared volume 104 having the volume ID “4”.

FIGS. 5A and 5B are diagrams illustrating examples of address translation tables 142A, 142B, 142C, 142D, and 142E (hereinafter, also collectively referred to as the “address translation table 142” when it is not necessary to distinguish them from each other) for managing a correspondence relation between a logical address, which indicates a storage address of data, and a physical address. FIG. 5A is an example of the address translation table 142 including an invalid value, and FIG. 5B is an example of the address translation table 142 not including an invalid value.

The address translation table 142 manages a correspondence relation between a logical address 1421, which indicates a start address of a storage area in which data is stored, and a physical address 1422. In the present embodiment, since data is processed in units of pages, the physical address 1422 in FIGS. 5A and 5B is indicated by a page number.

When a value of the physical address 1422 is a valid value such as “0” or “2”, it means that data is stored in a host data center holding the address translation table 142. Meanwhile, when the value of the physical address 1422 is an invalid value (Invalid) such as “FFFFFFFF“(for example, see FIG. 5A), it indicates that data is stored in the logical address 1421 of a straight-mapped page 120 in the host data center (the same address as the logical address 1421 of the accessed virtual volume). For example, when the accessed virtual volume is a local clone volume and is straight-mapped to the pool 110, and the pool 110 is externally connected to a virtual volume of a clone source data center, it means that actual data is stored in the clone source data center.

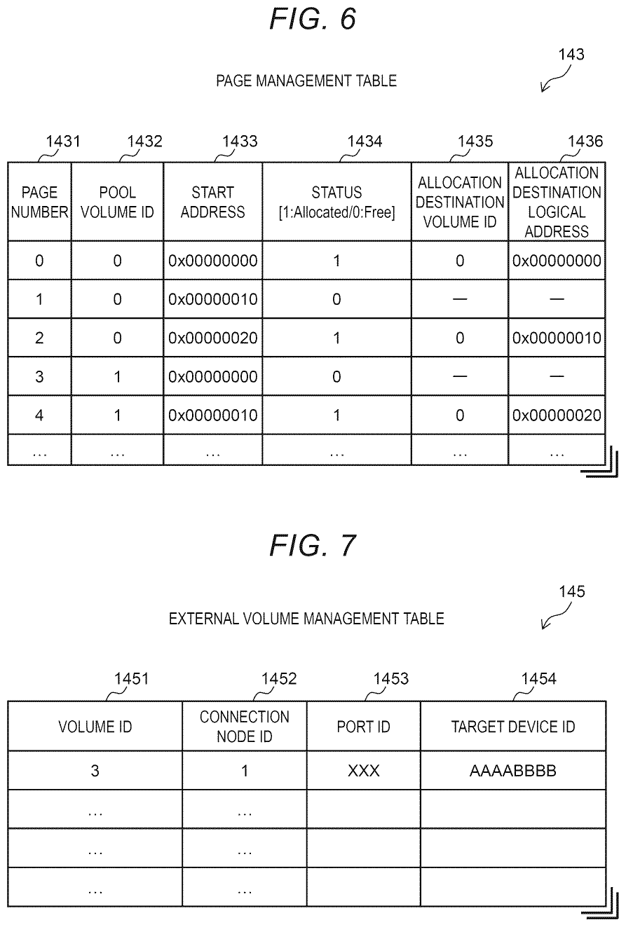

FIG. 6 is a diagram illustrating an example of the page management table 143. The page management table 143 is control data for managing pages. The page management table 143 includes items which are a page number 1431, a pool volume ID 1432, a start address 1433, a status 1434, an allocation destination volume ID 1435, and an allocation destination logical address 1436.

The page number 1431 indicates an identifier (page number) allocated to each page. The pool volume ID 1432 indicates a volume ID of the page 120 that stores actual data of a page identified by the page number 1431 (hereinafter referred to as the page). The start address 1433 indicates a start address of actual data of a page stored in the pool volume ID 1432.

The status 1434 indicates whether the page is allocated to a page of the primary volume 101. The allocation destination volume ID 1435 indicates a volume ID of the primary volume 101 to which the page is allocated, and the allocation destination logical address 1436 indicates a logical address (start address) of the page allocated to the primary volume 101.

FIG. 7 is a diagram illustrating an example of the external volume management table 145. The external volume management table 145 is control data for managing a volume (external volume) externally connected from another data center. The external volume management table 145 includes items which are an external volume ID 1451, a connection node ID 1452, a port ID 1453, and a target device ID 1454. The external volume ID 1451 indicates an identifier assigned to an external volume in the host data center.

The connection node ID 1452 indicates a data center ID indicating a connection source data center of an external volume (hereinafter, the external volume) identified by the external volume ID 1451. The data center ID is an identifier capable of uniquely identifying a plurality of data centers constituting the storage device 100. The port ID 1453 indicates an identifier of a port of a host data center to which the external volume is connected, and the target device ID 1454 indicates an identifier of a target device holding actual data of the external volume in the connection source data center.

### (1-3) Processing

Hereinafter, as processing executed by the storage system according to the present embodiment, “clone creation processing” of creating a clone volume as a clone of a certain volume, “write processing” executed in response to a write request to the clone, “read processing” executed in response to a read request to the clone, and “clone deletion processing” of deleting the clone will be described in detail. In the present embodiment, a volume from which a clone volume is created is also referred to as a “clone source”.

### (1-3-1) Clone Creation Processing

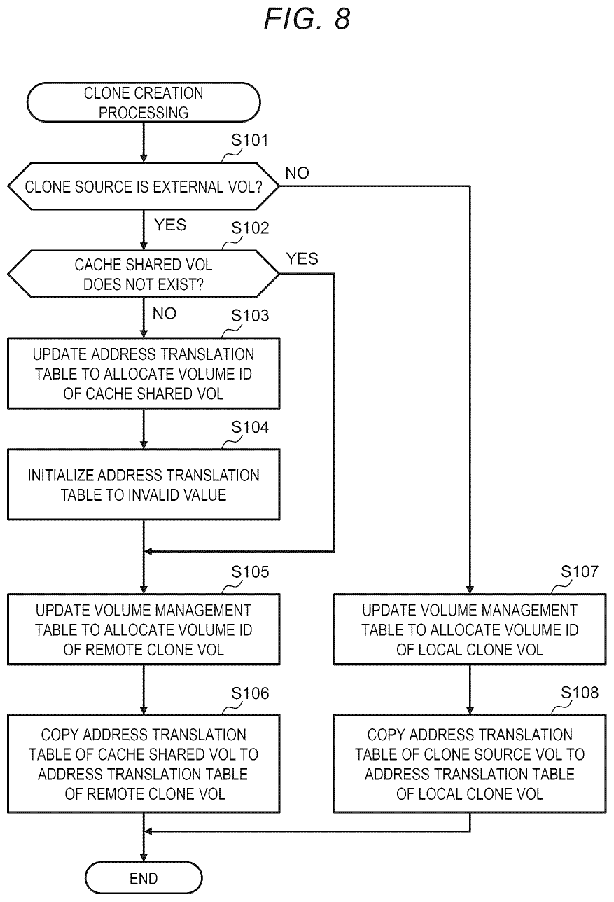

FIG. 8 is a flowchart illustrating an example of a procedure of the clone creation processing. The clone creation processing is executed by the clone creation program 151.

In step S101, the clone creation program 151 determines whether the clone source is the external volume 105. In the present embodiment, the remote clone volume 103 is selected if the clone source is the external volume 105, and the local clone volume is selected if the clone source is not the external volume 105. The clone creation program 151 executes step S102 if it is determined in step S101 that the clone source is the external volume 105, and executes step S107 to be described later if it is determined that the clone source is not the external volume 105.

In step S102, the clone creation program 151 determines whether the cache shared volume 104 does not exist. The clone creation program 151 executes step S103 if it is determined that the cache shared volume 104 does not exist, and executes step S105 to be described later if it is determined that the cache shared volume 104 exists.

In step S103, the clone creation program 151 updates the volume management table 141 so as to newly allocate a volume ID of the cache shared volume 104. Specifically, the clone creation program 151 updates the volume type 1414 for the volume ID “4” of the cache shared volume 104 in the volume management table 141 to “Virtual VOL (Cache Shared)”.

In step S104, the clone creation program 151 initializes address information in the address translation table 142C to an invalid value. A reason why initialization is performed to an invalid value is that the cache shared volume 104 is newly created and there is no storage address information in which data is stored.

In step S105, the clone creation program 151 updates the volume management table 141 so as to allocate a volume ID of a newly created remote clone volume 103. Specifically, for example, when volume IDs of the newly created remote clone volume 103 are “5” and “6” in the volume management table 141, the clone creation program 151 updates the cache shared VOL ID 1416 of the cache shared volume 104 to “4” for the volume IDs “5” and “6”.

In step S106, the clone creation program 151 copies the address translation table 142C corresponding to the cache shared volume 104 as the address translation table 142D of the remote clone volume 103.

Meanwhile, as described above, if it is not determined in step S101 that the clone source is the external volume 105, in step S107, the clone creation program 151 updates the volume management table 141 so as to allocate a volume ID of the local clone volume. Specifically, for example, if the volume ID of the local clone volume is “2” in the volume management table 141, the clone creation program 151 updates the cache shared VOL ID 1416 of the cache shared volume 104 to a volume ID of the local clone volume for the volume ID “2”.

In step S108, the clone creation program 151 copies an address translation table (not illustrated) corresponding to a clone source volume as an address translation table of the local clone volume.

### (1-3-2) Clone Deletion Processing

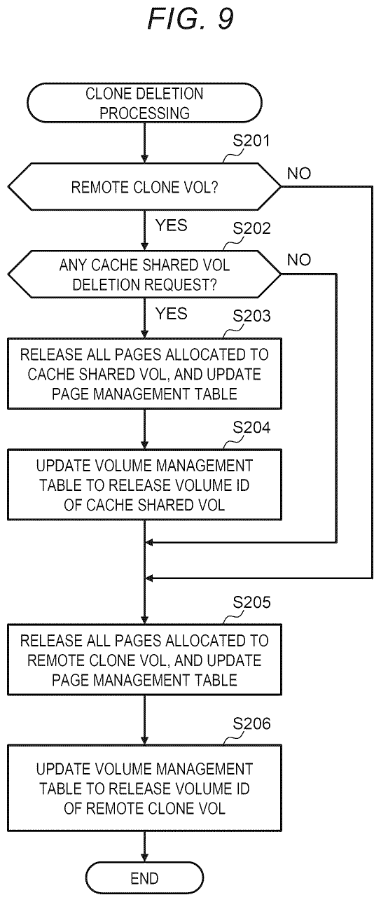

FIG. 9 is a flowchart illustrating an example of a procedure of the clone deletion processing. The clone deletion processing is executed by the clone deletion program 152.

In step S201, the clone deletion program 152 determines whether a target volume is the remote clone volume 103. The clone deletion program 152 executes step S202 if the target volume is the remote clone volume 103, and executes step S205 to be described later if the target volume is not the remote clone volume 103.

In step S202, the clone deletion program 152 determines whether there is a deletion request for the cache shared volume 104. The clone deletion program 152 executes step S203 if there is a deletion request for the cache shared volume 104, and executes step S205 to be described later if there is no deletion request for the cache shared volume 104.

In step S203, the clone deletion program 152 releases all pages allocated to the cache shared volume 104 and updates the page management table 143. Specifically, the clone deletion program 152 updates a page number of a page of the cache shared volume 104 to the allocation destination volume ID 1435 “-” and updates the allocation destination logical address 1436 to “-” in the page management table 143.

In step S204, the clone deletion program 152 releases the volume ID of the cache shared volume 104 and updates the volume management table 141. Specifically, the clone deletion program 152 updates the volume type 1414 indicating the cache shared volume 104 in the volume management table 141 from “Virtual VOL (Cache Shared)” to, for example, “-”. In step S205, the clone deletion program 152 releases all pages allocated to the remote clone volume 103 and updates the page management table 143. Specifically, the clone deletion program 152 updates a page number of a page of the remote clone volume 103 to the allocation destination volume ID 1435 “-” and updates the allocation destination logical address 1436 to “-” in the page management table 143.

In step S206, the clone deletion program 152 releases the volume ID of the local clone volume and updates the volume management table 141. Specifically, the clone deletion program 152 updates the volume type 1414 indicating the local clone volume in the volume management table 141 from “Virtual VOL (Local Clone)” to, for example, “-”.

### (1-3-3) Write Processing

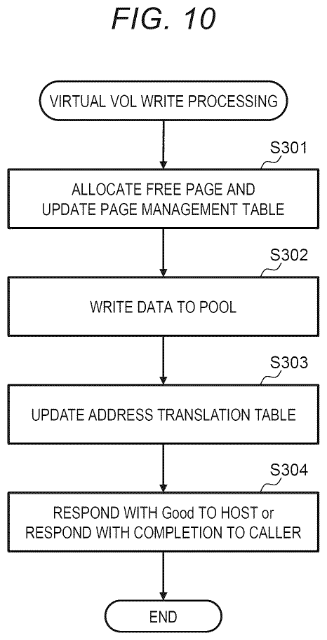

FIG. 10 is a flowchart illustrating an example of a procedure of virtual VOL write processing. The virtual VOL write processing is executed by the virtual VOL write program 153.

In step S301, the virtual VOL write program 153 allocates a free page and updates the page management table 143. Specifically, the virtual VOL write program 153 allocates a page with a page number in which the allocation destination volume ID 1435 in the page management table 143 is “-”, and updates the allocation destination volume ID 1435 of the page management table 143 for the page number to which the page is allocated to an allocated volume ID for a data write destination volume. In step S302, the virtual VOL write program 153 writes data to the pool 110 including the page.

In step S303, the virtual VOL write program 153 updates the address translation table 142D corresponding to the remote clone volume 103. In step S304, the virtual VOL write program 153 responds with “Good” to the data analysis server 12 or responds with completion to a caller. Accordingly, the data analysis server 12 or the like recognizes that preparation for writing data to the remote clone volume 103 is completed, and starts writing the data to the remote clone volume 103.

### (1-3-4) Virtual VOL Read Processing

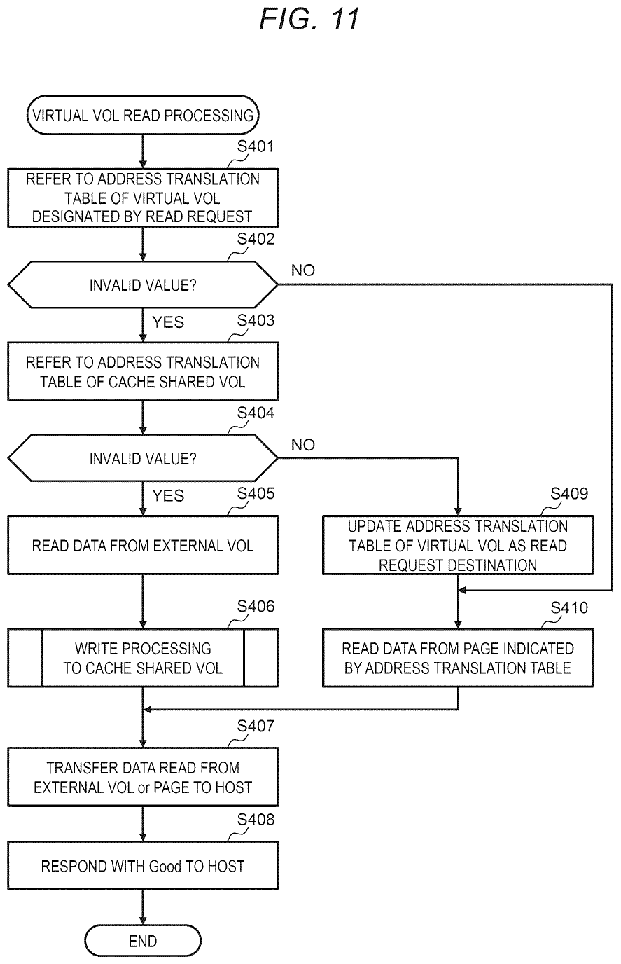

FIG. 11 is a flowchart illustrating an example of a procedure of virtual VOL read processing. The virtual VOL read processing is executed by the virtual VOL read program 154.

In step S401, the virtual VOL read program 154 refers to an address translation table of a virtual volume designated in a read request. In step S402, the virtual VOL read program 154 determines whether there is an invalid value in the address translation table. The virtual VOL read program 154 executes step S403 if it is determined that there is an invalid value, and executes step S410 to be described later if it is determined that there is no invalid value.

In step S403, the virtual VOL read program 154 refers to the volume management table 141, specifies an ID of a cache shared VOL corresponding to the virtual VOL, and refers to an address translation table 142C of a cache shared volume 104 corresponding to the ID.

In step S404, the virtual VOL read program 154 determines whether there is an invalid value in the address translation table 142C. The virtual VOL read program 154 executes step S405 if it is determined that there is an invalid value, and executes step S409 if it is determined that there is no invalid value.

In step S409, the virtual VOL read program 154 updates address information of the address translation table of the virtual volume as a read request destination to a physical address acquired in step S404. In step S410, the virtual VOL read program 154 reads data based on the address information indicated by the address translation table.

Meanwhile, in step S405, the virtual VOL read program 154 reads data from the external volume 105. In step S406, the virtual VOL read program 154 executes write processing to the cache shared volume 104.

In step S407, the virtual VOL read program 154 transfers data read from the external volume 105 or a page of the virtual volume as the read request destination to the data analysis server 12 as an example of the host device. In step S408, the virtual VOL read program 154 responds with “Good” to the data analysis server 12. Accordingly, the data analysis server 12 or the like recognizes that preparation for reading data from the virtual volume as the read request destination is completed, and starts reading data from the virtual volume as the read request destination.

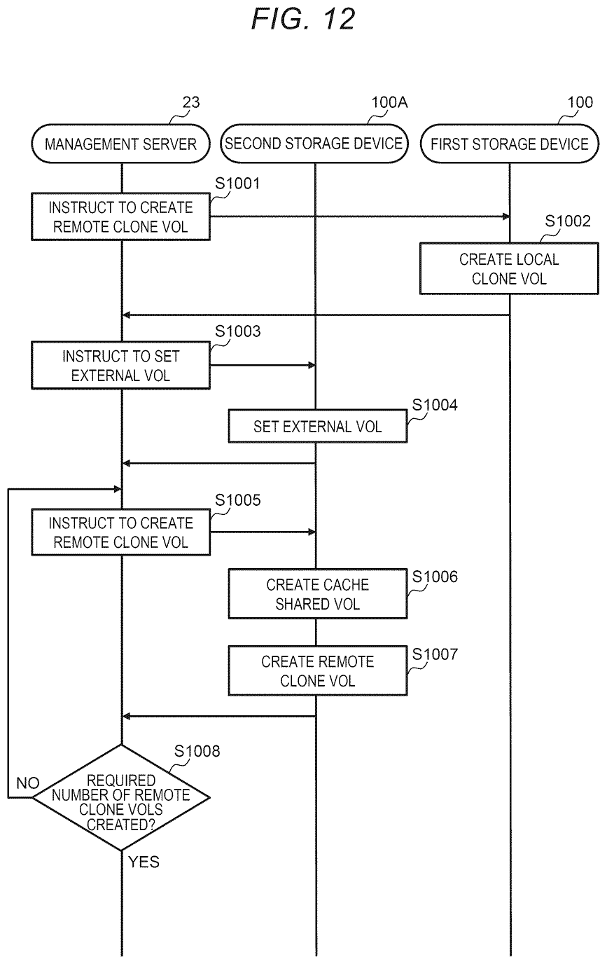

FIG. 12 is a timing chart illustrating an example of a procedure of a storage control method according to the present embodiment. As an outline of the storage control method, in the storage control method for the storage system including the first storage device 100 and the second storage device 100A each having a processor and the pool 110 and connected via the network 2 or the like, the first storage device 100 includes the primary volume 101, the second storage device 100A includes a plurality of clone volumes 103 that are clones of the primary volume 101, and the second storage device 100A stores data of the clone volume 103 in the pool 110 of the second storage device 100A, and when the data is not stored in the pool 110 of the second storage device 100A, acquires the data from the pool 110 of the first storage device 100 and stores the data in the pool 110 of the second storage device 100A, and enables data related to the primary volume 101 stored in the pool 110 of the second storage device 100A to be commonly accessed by the plurality of clone volumes 103. Since updating of the page management table 143, the volume management table 141, and the like associated with the following processing is already described, the description thereof will be omitted.

In step S1001, the management server 23 instructs the first storage device 100 to create a local clone volume. In step S1002, the first storage device 100 creates a local clone volume.

In step S1003, the management server 23 instructs the second storage device 100A to set the external volume 105. In step S1004, the second storage device 100A sets the external volume 105.

In step S1005, the management server 23 instructs the second storage device 100A to create the remote clone volume 103. In step S1006, the second storage device 100A creates the cache shared volume 104. In step S1007, the second storage device 100A copies the cache shared volume 104 to create the remote clone volume 103.

In step S1008, the management server 23 determines whether a required number of remote clone volumes 103 is created, and repeatedly executes step S1005 described above if the required number of remote clone volumes 103 is not created, and ends the processing if the required number of remote clone volumes 103 is created.

### (2) Second Embodiment

Since a storage system according to a second embodiment has a similar configuration and operation as the storage system according to the first embodiment, description of the similar configuration and operation will be omitted, and different points will be mainly described below. In the present embodiment, when the data is stored in the pool 110 of the second storage device 100A, the second storage device 100A reads the data of the accessed remote clone volume 103 from the pool 110 of the second storage device 100A and transmits the data to an access request source, and when the data is not stored in the pool 110 of the second storage device 100A, the second storage device 100A acquires the data from the pool 110 of the first storage device 100, transmits the data to the access request source, and stores the acquired data in the pool 110 of the second storage device 100A.

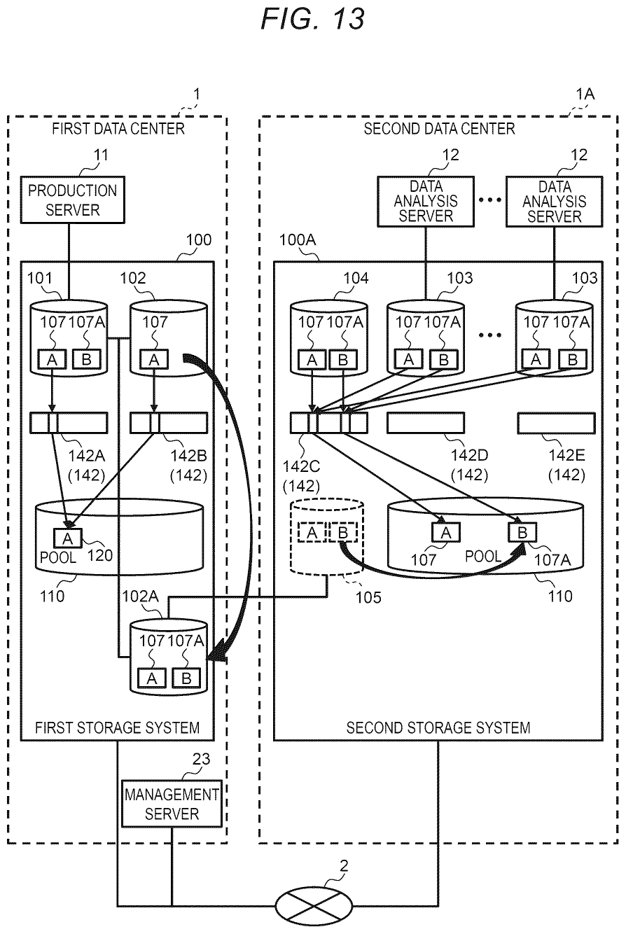

FIG. 13 is a block diagram illustrating an example of a logical configuration of the storage system according to the second embodiment. In the illustrated example, a part of the flow of creating a snapshot volume 102A is simplified for the convenience of an illustrated space.

In the first embodiment described above, the snapshot volume 102 of the primary volume 101 is acquired at a certain point in time in the first storage device 100, but it is not assumed, for example, a situation in which new data is written to the primary volume 101 (or may be a situation in which data is deleted, for example) after this point in time, but in the second embodiment, this situation is assumed. In the second embodiment, when a snapshot as a reference destination is changed to a new snapshot, data is prefetched using snapshot difference information (a difference written after an old snapshot), and prefetched data acquired from the old snapshot is used as it is. A specific example of the above situation is as follows, taking data writing as an example.

In the first storage device 100 in the first data center 1, the production server 11 further writes new data to the primary volume 101 already having the page 107 of “A”. The new data is stored in the primary volume 101 as a page 107A of “B”, for example.

Here, in the first storage device 100, in response to a snapshot creation instruction issued by the management server 23, a snapshot volume 102A is created that follows the snapshot volume 102 for the primary volume 101 and includes the page 107A of “B” related to subsequent data write (for example, see a black arrow in the figure near the snapshot volumes 102 and 102A). The snapshot volume 102A includes not only the page 107 of “A” but also the page 107A of “B”.

For example, in the case of FIG. 13, the snapshot volume 102A is associated with the page 120, and an address of the page 107 of “A” and the page 107A of “B” of the snapshot volume 102A is translated by the address translation table 142B and allocated to the page 120 of “A” and a page of “B“(not illustrated) in the pool 110.

As described above, the external volume 105 corresponds to the primary volume 101, and the page 107A of “B” is reflected in accordance with the snapshot volume 102A of the primary volume 101. Accordingly, the external volume 105 includes the page 107 of “A” and the page 107A of “B”.

As described above, the cache shared volume 104 reflects the snapshot volume 102A described above so as to correspond to the primary volume 101 via the external volume 105, and address information thereof is registered in the address translation table 142C. In the present embodiment, such processing is referred to as “cache shared VOL synchronization processing”.

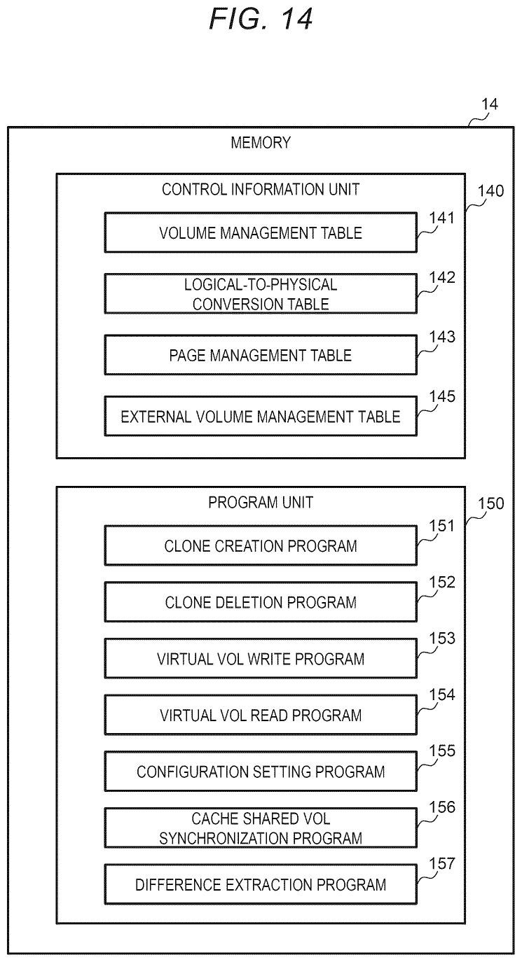

FIG. 14 is a diagram illustrating a configuration example of the memory 14 according to the second embodiment. Programs and the control data stored in the memory 14 are executed and used by the processor 13.

In the second embodiment, a cache shared VOL synchronization program 156 and a difference extraction program 157 are further provided in addition to a memory configuration in the first embodiment.

The cache shared VOL synchronization program 156 has a function of synchronizing the external volume 105 and the cache shared volume 104. The cache shared VOL synchronization program 156 reads data from the external volume 105 based on difference position information received from the management server 23, and writes the data to the cache shared volume 104.

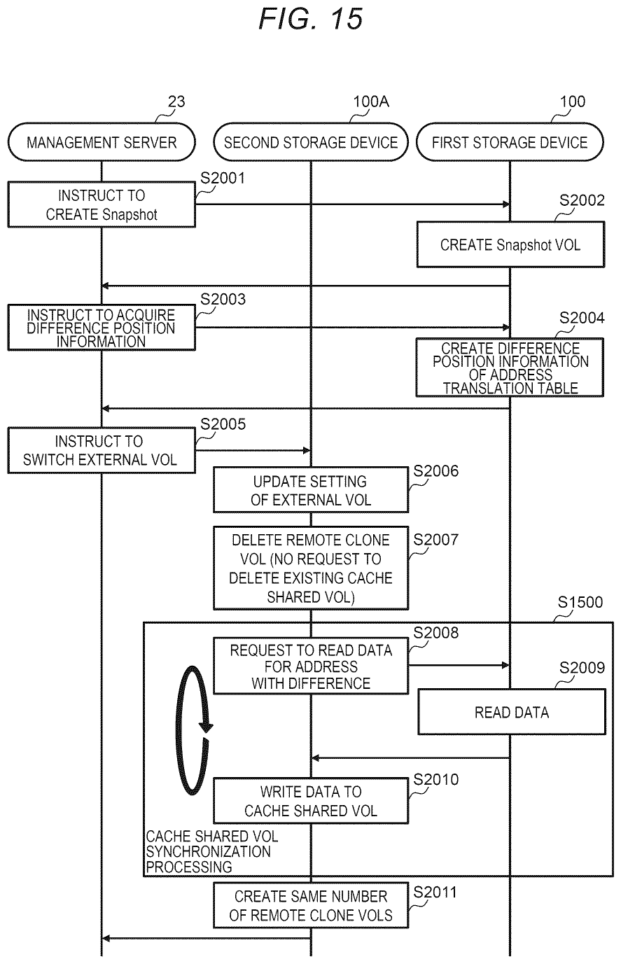

The difference extraction program 157 has a function of comparing entire logical-to-physical conversion tables of two snapshots and creating difference position information. The difference position information is a list of logical addresses to which different physical addresses correspond. For example, since the page 107 of “A” in which writing is completed and the page 107A of “B” store different data for the same logical address and correspond to different physical addresses, the difference extraction program 157 performs an operation to add a logical address of the page 107A to the difference position information. FIG. 15 is a sequence chart illustrating an example of a procedure for switching the external volume 105 to a new snapshot volume 102.

In step S2001, the management server 23 instructs the first storage device 100 to create a snapshot of the primary volume 101. In step S2002, the first storage device 100 creates a new snapshot volume 102A for the primary volume 101.

In step S2003, the management server 23 instructs the first storage device 100 to acquire difference position information between the snapshot 102A created in step S2002 and the snapshot 102 that is set as the external volume 105 at this point in time. In step S2004, the first storage device 100 creates difference position information.

In step S2005, the management server 23 instructs the second storage device 100A to switch the external volume 105. An instruction to switch the external volume 105 includes, for example, a difference prefetch request, a volume ID of the snapshot volume 102A, and difference position information.

In step S2006, the second storage device 100A updates setting of the external volume 105 in response to the instruction to switch the external volume 105. In step S2007, the second storage device 100A deletes an existing remote clone volume 103. Here, it is assumed that there is no request from the management server 23 to delete the cache shared volume 104.

Step S1500 is cache shared VOL synchronization processing. The cache shared VOL synchronization processing includes step S2008 to step S2010.

In step S2008, the second storage device 100A requests the first storage device 100 to read data based on address information corresponding to a difference, for example, the page 107A of “B”. In step S2009, the first storage device 100 reads data and transmits the data to the second storage device 100A.

In step S2010, the second storage device 100A writes data to the cache shared volume 104. Details of the cache shared VOL synchronization processing will be described later.

Finally, in step S2011, the second storage device 100A creates the same number of remote clone volumes 103 as the number of data analysis servers 12 by copying the cache shared volume 104.

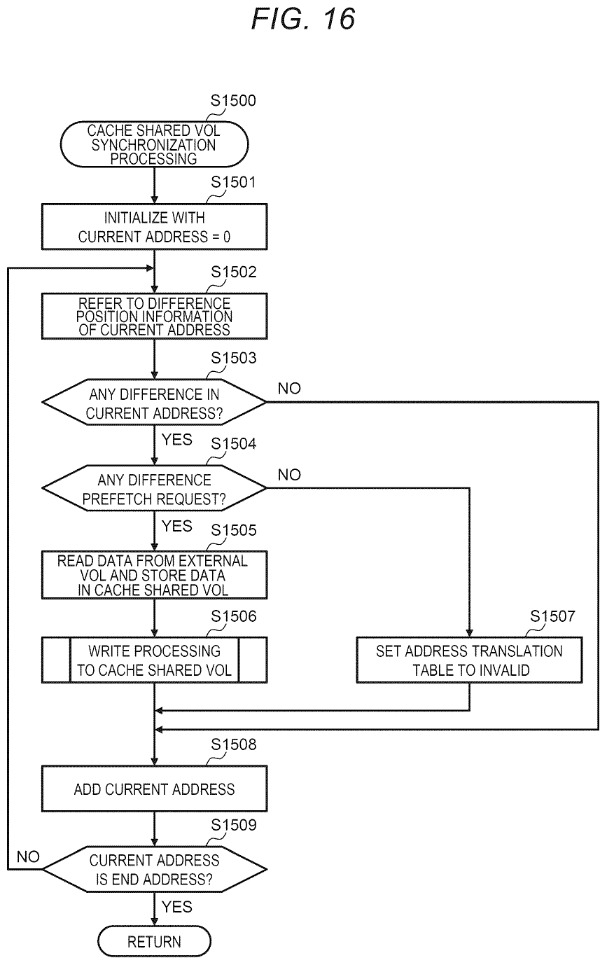

FIG. 16 is a flowchart illustrating an example of a procedure of the cache shared VOL synchronization processing (step S1500) illustrated in FIG. 15. The cache shared VOL synchronization processing is executed by the configuration setting program 155.

In step S1501, the second storage device 100A initializes a current address of the address translation table 142C corresponding to the cache shared volume 104 to “0”.

In step S1502, the second storage device 100A refers to difference position information of the current address. In step S1503, the virtual VOL write program 153 determines whether there is a difference in the current address. The second storage device 100A executes step S1504 if it is determined that there is a difference, and executes step S1508 if it is determined that there is no difference.

In step S1504, the second: storage device 100A determines whether there is a difference prefetch request. The second storage device 100A executes step S1505 if there is a difference prefetch request, and executes step S1507 if there is no difference prefetch request.

In step S1505, the first storage device 100 reads data from the external volume 105. Specifically, the first storage device 100 reads data from a current address of the external volume 105. In step S1506, the virtual VOL write program 153 executes processing of writing data to a current address of the cache shared volume 104.

Meanwhile, in step S1507, if there is no difference prefetch request from the management server 23, for example, the second storage device 100A sets the address translation table 142C corresponding to the cache shared volume 104 to invalid. The invalidation in step S1507 is executed, for example, in order to make it possible to use previous data before the latest data when it is not necessary to use the latest data (when there is no difference prefetch request).

In step S1508, the second storage device 100A adds, for example, a predetermined offset address to the current address in order to handle next data. In step S1509, the second storage device 100A determines whether the current address is an end address of the external volume 105, and if the current address is the end address, ends the cache shared VOL synchronization processing, returns to processing of a caller, and executes the next step (step S2011), and if the current address is not the end address, returns to step S1502 described above and executes the steps thereafter.

The storage system according to the present embodiment described above includes the first storage device 100 and the second storage device 100A each having the processor and the pool and connected via the network. The first storage device 100 includes the primary volume 101, the second storage device 100A includes the plurality of clone volumes 103 that are clones of the primary volume 101, and the second storage device 100A stores data of the clone volume 103 in the pool of the second storage device 100A, and when the data is not stored in the pool 110 of the second storage device 100A, acquires the data from the pool 110 of the first storage device 100 and stores the data in the pool 110 of the second storage device 100A, and enables data related to the primary volume 101 stored in the pool 110 of the second storage device 100A to be commonly accessed by the plurality of clone volumes 103.

According to the present embodiment described above, regarding the acquisition of the data of the primary volume 101 in the first storage device 100 through at least one remote clone volume 103 of the second storage device 100A, since data copying is not performed using the network 2 between the storage devices when the remote clone volume 103 is created, the remote clone volume 103 can be quickly created. In addition, by holding the data read from the primary volume 101 in the cache shared volume 104, when read access to the same data occurs in different remote clone volumes 103, the number of times data is copied between the first storage device 100 and the second storage device 100A using the network 2 between storage devices can be reduced to one, so that performance can be improved. Accordingly, it is possible to speed up data access in the second environment while reducing a load of the network bandwidth between the first environment and the second environment and reducing power consumption of the network. In this way, since a storage capacity for writing data can be reduced to one time, cost can also be reduced.

The storage control method for a storage system according to the present embodiment is a storage control method for the storage system including the first storage device 100 and the second storage device 100A each having the processor and the pool and connected via the network, and the first storage device 100 includes the primary volume 101, the second storage device 100A includes the plurality of clone volumes 103 that are clones of the primary volume 101, and the second storage device 100A stores data of the clone volume 103 in the pool of the second storage device 100A, and when the data is not stored in the pool of the second storage device 100A, acquires the data from the pool of the first storage device 100 and stores the data in the pool 110 of the second storage device 100A, and enables data related to the primary volume 101 stored in the pool 110 of the second storage device 100A to be commonly accessed by the plurality of clone volumes 103.

In the storage system according to the present embodiment, the plurality of clone volumes 103 can access data of the same primary volume 101, and the data can be written to the plurality of clone volumes 103 separately. In the storage system according to the embodiment, the second storage device 100A includes the first address translation table 142C for accessing the data related to the primary volume 101, and the second address translation tables 142D to 142E for each of the plurality of clone volumes 103, accesses, via the first address translation table 142C, data that is related to the primary volume 101 and stored in the pool 110 of the first storage device 100 and the pool 110 of the second storage device 100A, and accesses, via the second address translation tables 142D to 142E, data written to the clone volume 103 and stored in the pool 110 of the second storage device 100A.

In the embodiment, the clone volume 103 refers to the second address translation tables 142D to 142E for data to be written to the clone volume 103, refers to the first address translation table 142C for the data related to the primary volume 101, and when the data related to the primary volume 101 is acquired from the first storage device 100 and stored in the second storage device 100A, changes a reference destination of the first address translation table 142C from the pool 110 of the first storage device 100 to the pool 110 of the second storage device 100A.

In the embodiment, when the clone volume 103 is created in the second storage device 100A, the first storage device 100 has a snapshot of the primary volume 101, and the second storage device 100A creates the cache shared volume 104 and the first address translation table 142C that is an address translation table referred to by the cache shared volume 104 and that refers to the snapshot volume via the external volume 105, and copies the cache shared volume 104 to create the clone volume referring to the first address translation table 142C, and creates the second address translation tables 142D to 142E in which a storage destination address of the data written in the clone volume 103 is registered.

In the embodiment, the plurality of clone volumes 103 are implemented by copying the plurality of cache shared volumes 104, and the second address translation tables 142D to 142E are provided in a number corresponding to the plurality of remote clone volumes 103.

In the embodiment, when the data is stored in the pool 110 of the second storage device 100A, the second storage device 100A reads the data of the accessed clone volume 103 from the pool 110 of the second storage device 100A and transmits the data to an access request source, and when the data is not stored in the pool 110 of the second storage device 100A, the second storage device 100A acquires the data from the pool 110 of the first storage device 100, transmits the data to the access request source, and stores the acquired data in the pool 110 of the second storage device 100A.

In the embodiment, when there is a prefetch request, the data is acquired from the pool 110 of the first storage device 100 and stored in the pool 110 of the second storage device 100A.

In the embodiment, the first storage device 100 has a plurality of snapshots created at different times for the same primary volume 101, when changing a reference destination snapshot of the first address translation table 142C to another snapshot created from the same primary volume 101, uses difference information between the snapshot before the change and the snapshot after the change to acquire data related to a difference from the first storage device 100, and stores the data in the pool 110 of the second storage device 100A, and after the reference destination snapshot is changed, accesses the data stored in the pool 110 of the second storage device 100A before the change and after the change from the clone volume 103.

The invention is not limited to the above-described embodiment, and includes various modifications and equivalent configurations within the scope of the appended claims. For example, the above-described embodiment has been described in detail to facilitate understanding of the invention, and the invention is not limited to those including all the above-described configurations. At least one of the elements described as being connected in parallel in the present embodiment may be connected in series to another element.

### INDUSTRIAL APPLICABILITY

The invention can be applied to a storage system relating to a technique for copying data via a network between a first environment and a second environment.

What is claimed is:

1. A storage system comprising:
a first storage device and a second storage device each having a processor and a pool and connected via a network, wherein
the first storage device includes a primary volume,
the second storage device includes a plurality of clone volumes that are clones of the primary volume, and
the second storage device
stores data of each of the clone volumes in the pool of the second storage device, and when the data is not stored in the pool of the second storage device, acquires the data from the pool of the first storage device and stores the data in the pool of the second storage device, and
enables data related to the primary volume stored in the pool of the second storage device to be commonly accessed by the plurality of clone volumes.

2. The storage system according to claim 1, wherein
the plurality of clone volumes are capable of accessing data of the same primary volume, and the data is capable of being written to the plurality of clone volumes separately.

3. The storage system according to claim 2, wherein
the second storage device
includes a first address translation table for accessing the data related to the primary volume, and a second address translation table for each of the plurality of clone volumes,
accesses, via the first address translation table, data that is related to the primary volume and stored in the pool of the first storage device and the pool of the second storage device, and
accesses, via the second address translation table, data written to each of the clone volumes and stored in the pool of the second storage device.

4. The storage system according to claim 3, wherein
each of the clone volumes
refers to the second address translation table for data to be written to the clone volume, refers to the first address translation table for the data related to the primary volume, and
when the data related to the primary volume is acquired from the first storage device and stored in the second storage device, changes a reference destination of the first address translation table from the pool of the first storage device to the pool of the second storage device.

5. The storage system according to claim 3, wherein
when the clone volume is created in the second storage device,
the first storage device has a snapshot of the primary volume, and
the second storage device
creates a cache shared volume and the first address translation table that is an address translation table referred to by the cache shared volume and that refers to a snapshot volume via an external volume, and
copies the cache shared volume to create the clone volume referring to the first address translation table, and creates the second address translation table in which a storage destination address of the data written in the clone volume is registered.

6. The storage system according to claim 5, wherein
the plurality of clone volumes are implemented by copying a plurality of the cache shared volumes, and
the second address translation table is provided in a number corresponding to the plurality of clone volumes.

7. The storage system according to claim 1, wherein
when the data is stored in the pool of the second storage device, the second storage device reads the data of the accessed one among the clone volumes from the pool of the second storage device and transmits the data to an access request source, and when the data is not stored in the pool of the second storage device, the second storage device acquires the data from the pool of the first storage device, transmits the data to the access request source, and stores the acquired data in the pool of the second storage device.

8. The storage system according to claim 1, wherein
when there is a prefetch request, the data is acquired from the pool of the first storage device and stored in the pool of the second storage device.

9. The storage system according to claim 3, wherein
the first storage device
has a plurality of snapshots created at different times for the same primary volume,
when changing a reference destination snapshot of the first address translation table to another snapshot created from the same primary volume, uses difference information between the snapshot before the change and the snapshot after the change to acquire data related to a difference from the first storage device, and stores the data in the pool of the second storage device, and
after the reference destination snapshot is changed, accesses the data stored in the pool of the second storage device before the change and after the change from the clone volume.

10. A storage control method for a storage system including a first storage device and a second storage device each having a processor and a pool and connected via a network,
the first storage device including a primary volume, the second storage device including a plurality of clone volumes that are clones of the primary volume, the storage control method comprising:
the second storage device
storing data of each of the clone volumes in the pool of the second storage device, and when the data is not stored in the pool of the second storage device, acquiring the data from the pool of the first storage device and storing the data in the pool of the second storage device, and
enabling data related to the primary volume and stored in the pool of the second storage device to be commonly accessed by the plurality of clone volumes.
